(19) United States
(12) Patent Application Publication
(10) Pub. No.: US 2020/0288822 A1
(43) Pub. Date: Sep. 17, 2020

(54) APPARATUS AND METHODS FOR IMPROVED OBJECT LEVELING

(71) Applicants: Thomas J. Fenoglio, New Lenox, IL (US); Joseph J. Fenoglio, Captiva, FL (US)

(72) Inventors: Thomas J. Fenoglio, New Lenox, IL (US); Joseph J. Fenoglio, Captiva, FL (US)

(21) Appl. No.: 16/817,026

(22) Filed: Mar. 12, 2020

Related U.S. Application Data
(60) Provisional application No. 62/817,046, filed on Mar. 12, 2019.

(51) Int. Cl. A44B 13/00; F16B 1/00

(52) U.S. Cl. CPC A44B 13/0029; F16B 2001/0028; F16B 1/00

(57) ABSTRACT

The present disclosure comprises an object straightener device sized and configured to be attached to the backside, bottom of an object, on the one hand, and attached to the wall that is holding the object, on the other hand. By attaching the object portion of the straightener device to the back of the object, and the wall portion of the straightener device to the wall, once the object is hung, and the desired position is attained, the object can be pressed against the wall, thereby bringing the wall portion and the object portion of the object straightener device into contact with each other and holding the object in the level position. The wall portion and the object portion can be detached from each other to reposition the object and then again attached to each other to hold the object in the newly desired position. Once implemented, the object straightener device will be hidden from the front, when the object is being viewed.

### CROSS-REFERENCE TO RELATED APPLICATION

This application claims priority to U.S. provisional application No. 62/817,046, filed Mar. 12, 2019, entitled APPARATUS AND METHODS FOR IMPROVED OBJECT LEVELING, which is hereby incorporated by reference in its entirety as though fully set forth herein.

### FIELD OF THE DISCLOSURE

The present disclosure relates to an improved object leveling device and methods, and in particular, the present disclosure relates to an improved object straightener device that is configured with attachable fasteners, such as hook and loop type fasteners, to keep with a picture, frame, mirror, clock or any other object that could be hung on the wall level and straight, and to keep the object level or properly positioned and from moving or rotating.

The present disclosure incorporates a straightening device sized and configured to be attached to the back side of an object, and attached to the wall. Once the object is properly hung and leveled or positioned, two separate portions can be attached to each other to hold the object in the level or desired position. Once implemented, the object straightener device will be hidden from view when the object is being viewed.

The present disclosure incorporates a straightening device sized and configured to be attached to the back side of an object, and attached to the wall, such that once the object is hung and properly positioned in a first position as the user desires, the two separate portions can be detached from each other so that the object can be repositioned to a second position desired by the user. Once repositioned, the object straightener device will be hidden from view when the object is being viewed.

### BACKGROUND OF THE INVENTION

There are a number of devices that can be used to ensure that a picture hung on a wall is level and straight. For example, the Hang & Level™ The Picture Hanging Tool, can be used to “accurately mark on your wall where to hammer the nail in. Includes a built-in level to make sure your pictures are straight. Perfect for pictures, mirrors, clocks and more.”

Also, the HANGables™ Removable Wall Fasteners state that “It's never been easier to hang frames and create wall collages. New VELCRO® Brand HANGables™ Removable Wall Fasteners are the perfect way to decorate. Frames go up without any hassles, and then when you want to remove them, they come down without any damage to your wall.” Other VELCRO® type frame installation systems exist that assist in hanging pictures and frames.

Additionally, there are various devices for ensuring that the picture or frame being hung is straight and/or level. For example, a manual level or laser level can be used to make sure the picture is level, once the proper height is determined. Many laser levels can be placed on a wall and will shine a level light across the wall to indicate when the picture is level.

Although there are numerous devices and products to assist one in hanging a picture and making sure the picture is level, there are not many products that can be used on a picture, frame, minor, clock or any other object that has already been hung to ensure that the object remains level. In some cases, a picture, for example, will have a piece of rubber or felt attached at the bottom rear corners of the picture in order to keep the picture from moving from its level position. Those felt or rubber piece are also intended to prevent the corners of the picture from sliding against and damaging the wall. However, the felt or rubber pieces placed on the rear side and the bottom corners of the picture do not completely prevent the picture from sliding. Once this occurs, the picture is no longer straight, and then the rubber or felt pieces work to keep the picture uneven.

Additionally, one may glue thumbtacks to the back of a picture with the tack facing the wall. Once the picture is determined to be level, the tack can be pressed into the wall to keep the picture in place and prevent the picture from sliding. However, pressing the thumbtack into the wall will create a permanent hole or mark that is not wanted, especially if the picture is later removed.

Therefore, there is a need for a straightening apparatus and methods, in which a picture, frame, mirror, clock or any other object that is hung through another product or procedure is prevented from moving from its straight position to an uneven position, and being capable of being repositioned to another position if the user's preference changes. There is a need for a device and related methods that will not damage a wall either during the hanging, straightening process or after the picture, frame, mirror, clock or any other object has been properly located, leveled and hung. The present disclosure satisfies these needs.

### SUMMARY OF THE DISCLOSURE

In general, in order to solve the above-mentioned shortcomings in the hanging, leveling and straightening process for pictures, frames, mirrors, clocks or any other objects (referred to herein as objects), the present disclosure utilizes an apparatus and related methods that incorporate a straightening device that is sized and configured to be attached to the back side, bottom of an object, on the one hand, and attached to the wall that is holding the object, on the other hand. As such, the present disclosure comprises two pieces or portions.

By attaching the portion of the straightener device (the object portion) to the back of the object, and portion of the straightener device to the wall (the wall portion), once the object is hung, and the level position (or any desired position) is attained, the object can be pressed against the wall, thereby bringing two portions into contact and holding the object in the level position. Once implemented (the object portion connected or attached to the wall portion), the object straightener device will be hidden and not seen from the front, when the object is being viewed. Further, once implemented, the object portion can be removed from the wall portion to reposition or readjust the object for a different angle or position.

The object straightener design does not function to, and is not capable of, holding the object to the wall, but instead keeps the object from sliding or rotating once the level position is attained. As such, the present disclosure design can be very small since the forces it needs to address are the side-to-side forces and the present disclosure does not have to overcome the gravitational forces of gravity pulling on the object. The present disclosure is meant to be used in conjunction with other object hanging products and structures.

The design of the two portions of the object straightener device can be any shape, including triangles, squares, circles, half-circles, or any other shape based on or irrespective of the shape of the object being hung. For example, if the hung object is a rectangle or square, the portions of the straightener device can be triangles or squares (for corner placement) or even circular, for placement in the bottom center of the object.

Further, the portions of the object straightener device can be any color based on the color of the wall, the color of the object or frame, the color of the frame or any combination thereof. In the preferred embodiment, the object straightener device is meant to be hidden from view, once the object has been hung, levelled and straightened.

As described herein, the present disclosure includes structures for improving object hanging devices and the methods of hanging an object to prevent sliding or rotating of the object on the wall. The present disclosure allows for easy repositioning and adjusting of objects that have previously been hung, which allows for the object to be repositioned later at a different angle, depending on the object. For example, if the object being hung is a decorative soup spoon, and it is originally hung parallel to the ground, there may be a desire to reposition it at 45 degrees. The present disclosure allows this repositioning.

In the preferred embodiment, these improvements comprise small object straightening devices, such as hook and loop type designs that comprise two pieces, a wall piece or section and an object piece or section. The wall section is configured to be located on the wall, and can be removed without damaging the paint or wallpaper. The object section is configured to be placed on the back of the object to be hung, to work with the wall section to accomplish the intended purpose. Each piece has, for example, either hook or loop functionality (opposite of the other) so that when pressed together, the two pieces will hold together until enough force is applied to pry them apart. Other attraction items can be used to accomplish the same function, such as temporarily adhering glue or tape, magnets, etc.

Additionally, each piece will have an adhesive backing, or some other backing, on the non-hook and non-loop sides, such that the wall piece can be adhered to the wall and the object piece can be adhered to the backside of the object. Once the wall piece is adhered to the wall and the object piece is adhered to the object, the object, which is hung on the wall through other means, can be lined up to be level or straight. At this point, the object can be pressed against the wall thereby connecting the hook and loop pieces and holding the object level and straight and from rotating or turning from that level position. Since the object straightening device is not holding the object to the wall, the object piece and the wall piece do not have to be lined up exactly. Only a portion of each needs to connect with the other to hold the object level or straight.

It is therefore an objective of the present disclosure to provide an object straightener device, such as a hook and loop device, which comprises two portions, a wall portion and an object portion. In the preferred embodiment, these two portions are the same or similar in size and configuration and color, for example a triangle or circle. However, either of the portions can be smaller or larger than the other portion and still function in accordance with the invention described herein. In an embodiment, either the object side or the wall side (or both) are small enough to include only a couple or a few hooks or loops (or both) from the hook and loop functionality, just enough to hold the object in place, but that can barely be seen from the side or the bottom of the object. In another embodiment, a small magnet can be used on one side and a larger magnet can be used on the other side, so that the object can be moved into the desired position and it will remain there.

One of the portions, the wall portion has first side that contains a wall fastener material, and a second side that contains a wall adhesive material. The adhesive has the property that it can be adhered or attached to a wall, and later removed without damaging the wall. The other portion, the object portion has a first side that contains an object fastener material, such that the object fastener material will fasten or connect and hold with the wall fastener material on the wall portion. The second side of the object portion contains an object adhesive material that has the property that it can be adhered or attached to the backside of an object, and later removed without damaging the backside of the object.

It is another objective of the present disclosure to provide a method for positioning, leveling or straightening an object in which one or more object portions are attached or adhered to the back of an object using the object adhesive material, and one or more of the wall portions are attached or adhered to the wall where the object is to be hung (or where it has been hung) using the wall adhesive material. Once the object has been hung and is level or has been straightened (or in another intended position), the object can be pressed against the wall from the viewing side, thereby allowing the object fastener material on the object portion to make contact and fasten to the wall fastener material on the wall portion, thereby preventing the object from sliding or rotating out of the straight or level position (or any other intended position) at which the object was originally hung.

It is another objective of the present disclosure to provide a method for leveling or straightening an object in which one or more object portions are attached or adhered to the back of an object using the object adhesive material, and one or more of the wall portions are attached or adhered to the wall where the object is to be hung (or where it has been hung) using the wall adhesive material. Once the object has been hung and leveled in the intended position, and the object has been pressed against the wall from the viewing side to allow the object fastener material on the object portion to make contact and fasten to the wall fastener material on the wall portion. The object can be pulled away from the wall and repositioned using the same technique to position the object in the first place. In certain instances where a completely different angle is preferred, the wall portion can be removed from the wall and placed in a different location altogether to allow the object to be completely repositioned without the need to rehang the object. This repositioning allows the user the flexibility to change the position of the object without removing the object from the wall.

The present disclosure provides an object straightener device and an object portion that can be easily attached to the back of an object that is already hanging, or that is intended to be hung. The present disclosure also provides an object straightener device and a wall portion that can be easily attached to the wall where an object is already hanging, or where an object is intended to be hung. The present disclosure allows the object, once properly hung, to be leveled or straightened to its desired position and then easily secured in place by merely pressing the front of the object in the approximate location of the object straightener device, thereby bringing the object and wall fastener material from the object portion and the wall portion together, to hold until they are pulled apart to change the object. Once the object has been removed, the wall portion can be removed from the wall without damaging the wall or leaving an indication that it was there previously. Further, the object portion can be removed form the back of the object without damaging the object or leaving any indication that it was previously attached.

It is yet another objective of the present disclosure to provide an object straightener device that can be configured into numerous geometrical designs, such as triangle, square, rectangle, circular, or any combination of these, among others. Further, it is an objective of the present disclosure to provide an object straightener device that can be configured in many different colors to match the color of the wall, to match the color of the object, or even to be different from the wall or object. Additionally, it is an objective of the present disclosure that the object straightener device is hidden from view once the object has been leveled or straightened and is in the proper location. As to the latter function, either the wall portion or the object portion (or both) can be small enough to incorporate merely a couple or a few hook and/or loop structures for minimal contact, and still providing the desired functionality.

These and other aspects, features, and advantages of the present disclosure will become more readily apparent from the attached drawings and the detailed description of the preferred embodiments, which follow.

### DETAILED DESCRIPTION OF THE DRAWINGS

The preferred embodiments of the disclosure will be described in conjunction with the appended drawings provided to illustrate and not to the limit the disclosure, where like designations denote like elements, and in which:

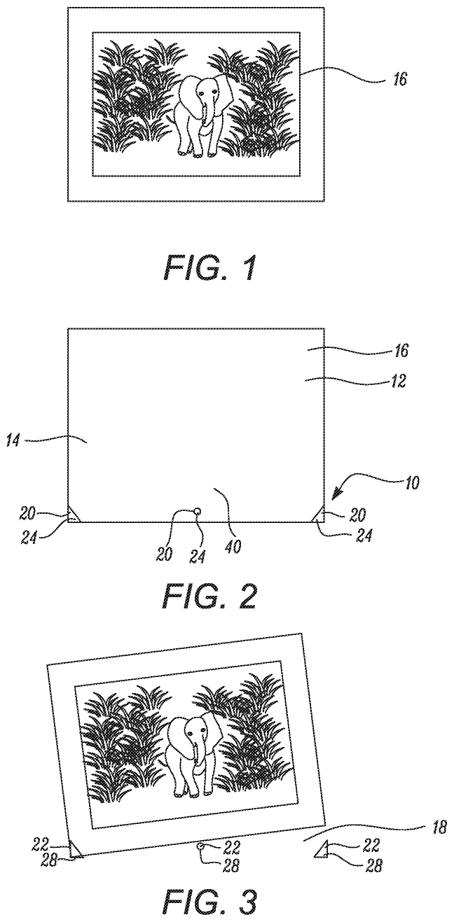

FIG. 1 illustrates the front side of a picture containing the object straightener device for positioning, straightening and leveling pictures in accordance with one embodiment of the present disclosure;

FIG. 2 illustrates the rear side of a picture containing the object straightener device for positioning, straightening and leveling pictures in accordance with one embodiment of the present disclosure;

FIG. 3 illustrates the front side and wall view of a picture containing the object straightener device for positioning, straightening and leveling pictures in accordance with one embodiment of the present disclosure; and

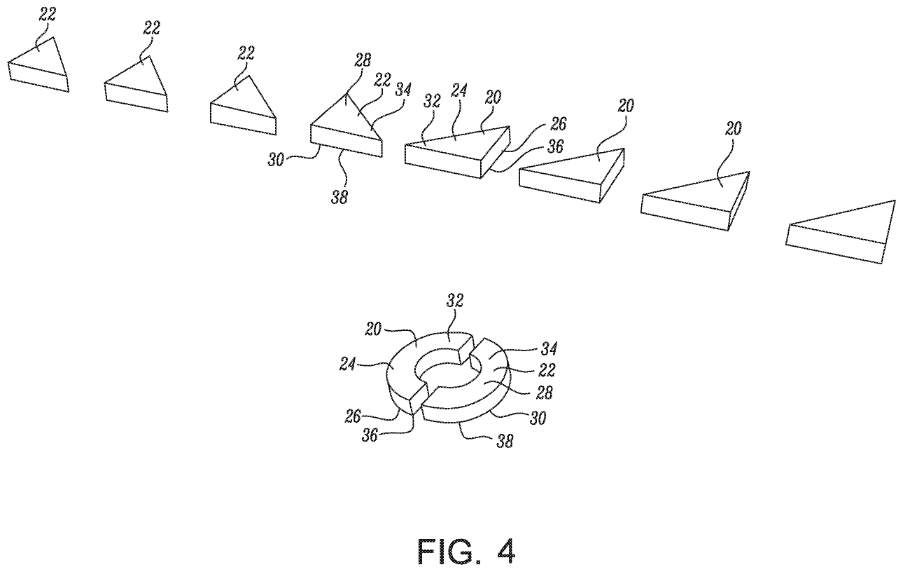

FIG. 4 illustrates the object straightener devices for positioning, straightening and leveling pictures in accordance with one embodiment of the present disclosure.

### DETAILED DESCRIPTION OF THE PRESENT DISCLOSURE

Referring to the drawings, wherein like reference numerals refer to the same or similar features in the various views, the present disclosure pertains to an improved object straightener device that is configured with attachable fasteners to keep an object that could be hung on a wall in the intended position, and to keep the object from moving or rotating.

FIGS. 1 through 4 show an improved object straightener device 10 and method for securing objects in their desired, level or straightened position, or in the position intended when the object was originally hung. Although the preferred embodiment shows a picture, one having ordinary skill in the art would understand that the straightening device could also be used on frames, mirrors, clocks or any other objects, and the disclosure is not limited to pictures.

The object straightener device 10 is not intended to hang or hold the object to the wall, but is instead intended to allow the user to easily position the object as intended, whether that position is level or otherwise, and to allow the user to easily reposition and/or modify the hanging position of the object from its original or first position to a repositioned or second position as the user's desires change.

FIGS. 1 through 4 also show an improvement to the method for securing pictures in their original intended, straight or level position, in accordance with the preferred and alternative embodiments of the present disclosure.

FIGS. 1, 2 and 3 show an apparatus and methods that incorporates an exemplary picture straightener device 10 that is sized and configured to be attached to the back side 12, bottom portion 14 of a picture or frame 16, on the one hand, and attached to the wall 18 that is holding the picture or frame 16, on the other hand. As detailed above, the picture 16 reference is meant to include any object that can be hung on a wall. Additionally, the object straightener device 10 does not function to, nor is it capable of, holding the picture 16 to the wall 18, but instead functions to keep the picture 16 from sliding or rotating once the desired or level position is attained. As such, the object straightener device 10 can be very small since the forces it needs to negate are the side-to-side forces and the object straightener device 10 does not need to function to overcome gravitational forces pulling on the picture 16. The object straightener device 10 is meant to be used in conjunction with other devices used to hang objects and structures.

The object straightener device 10 comprises a picture portion 20 and a wall portion 22. The picture portion 20 contains a picture first side 24 and a picture second side 26 (shown in FIG. 4), while the wall portion 22 contains a wall first side 28 and a wall second side 30 (shown in FIG. 4). The picture first side 24 comprises a picture fastener material 32, and the wall first side 28 comprises a wall fastener material 34. The picture second side 26 comprises a picture adhesive material 36, and the wall second side 30 comprises a wall adhesive material 38.

In use, the picture portion 20 of the straightener device 10 is attached or adhered to the back 12 and bottom portion 14 of the picture 16, using the picture second side 26 containing the picture adhesive material 36. Next, the wall portion 22 of the straightener device 10 is attached or adhered to the wall 18, using the wall second side 30 containing the wall adhesive material 38.

Once the picture 16 is properly hung on the wall using another device (see FIG. 3), and the intended position, whether that is the leveled or straightened position (or another position) is attained, the picture 16 can be pressed against the wall 18, thereby bringing the picture first side 24 containing the picture fastener material 32 into contact with the wall first side 28 containing the wall fastener material 34. The picture portion 20 will then be fastened to the wall portion 22 and the picture will be held in the level or straight position. Once implemented, the picture straightener device 10 will be hidden from the front, when the picture is being viewed (see FIG. 1).

Additionally, once the picture 16 has properly been hung in its intended position, and the picture 16 has been pressed against the wall 18 from the viewing side, the picture 16 can be pulled away from the wall 18 thereby releasing the picture fastener material 32 from the wall fastener material 34. This will allow the user to reposition the picture 16 and use the same technique to position the picture 16 in a different position on the wall 18. In certain instances, where a completely different angle is preferred, the picture 16 can be repositioned without the need to rehang the picture 16. This repositioning allows the user the flexibility to change the position of the picture without removing it from the wall 18.

The picture straightener device 10 does not function to, and is not capable of, holding the picture 16 to the wall 18, but instead keeps the picture 16 from sliding or rotating once the intended position is attained. As such, the present picture straightener device 10 can be very small, since the forces it needs to address are the side-to-side forces and the picture straightener device 10 does not have to overcome the force of gravity pulling on the picture or frame 16. For example, if the object straightener device 10 utilizes a hook and loop structure for attachment purposes, merely a few hooks or a few loops can be incorporated to provide the functionality described herein. The present disclosure is meant to be used in conjunction with other picture hanging products and structures.

FIGS. 2 and 3 show the preferred and an alternative embodiment. The two triangles 20 at the corners of the back 12 of the picture 16 comprise the preferred embodiment, while the circle 20 is an alternative embodiment that can be utilized alone or with other devices 10. The three devices 10 are not meant to be used together, although they could be used together and still be within the scope of the present disclosure.

FIG. 4 shows some different designs for the picture straightener device 10. The design of the two portions 20, 22 of the picture straightener device 10 can be triangles, squares, circles, half-circles, or any other shape based on the shape of the picture or frame 16 being hung on the wall 18 (FIG. 4 shows triangles and half circles).

For example, if a picture 16 being hung is a rectangle or square (see FIG. 1), the portions 20, 22 of the straightener device 10 can be triangles (shown) or squares for bottom 14 placement, or even half-circular (shown) for placement in the bottom 14 center 40 of the picture 16. Further, the portions 20, 22 of the picture straightener device 10 can be any color based on the color of the wall 18, the color of the picture of frame 16, or any combination of the two. In the preferred embodiment, the picture straightener device 10 is meant to be hidden from view, once the picture or frame 16 has been levelled and straightened on the wall 18.

As described herein, the present disclosure includes structures for improving picture hanging devices and the methods of hanging a picture 16 to prevent sliding or rotating of the picture 16 on the wall 18. In the preferred embodiment, these improvements comprise small picture straightening devices 10, such as hook and loop type designs that comprise two pieces, a wall piece and an object piece. The picture fastener material 32 and the wall fastener material 34 can be any material that will fasten the picture and wall portions 20, 22 together, for example, hook and loop fasteners, so that when the portions 20, 22 are pressed together, the two portions 20, 22 will hold together until enough force is applied to pry them apart.

Additionally, each portion 20, 22 will have the adhesive material 36, 38 located on the non-fastener sides 26, 30, such that the picture portion 20 can be adhered or attached to the back 12 of the picture 16, and the wall portion 22 can be adhered or attached to the wall 18. The adhesive materials 36, 38 may be the same materials for both or different materials. Further, each adhesive material 36, 38 located on the second sides 26, 30 of the picture or wall portions 20, 22, may have a cover (not shown) that may need to be removed before the portion 20, 22 is located on the picture 16 or wall 18, respectively. The adhesive material 36, 38 should be tacky enough to hold the portions 20, 22 in their respective locations, but not so tacky that the portions 20, 22 cannot be removed without damaging the picture 16 or the wall 18.

Once the wall portion 22 is adhered to the wall 18 and the picture portion 20 is adhered to the picture 16, the picture 16, which is hung on the wall 18 through other means, can be lined up to be level or straight. At this point, the picture 16 can be pressed against the wall 18 thereby connecting the fastener materials 32, 34 and holding the picture 16 level and straight and from rotating or turning from that level position. Since the picture straightener device 10 is not holding the picture 16 to the wall 18, the picture portion 20 and the wall portion 22 do not have to be lined up exactly. Only an overlap of each portion 20, 22 is needed to connect and hold the picture 16 level or straight on the wall 18.

It will be understood that the embodiments of the present disclosure, which have been described, are illustrative of some of the applications of the principles of the present disclosure. Although numerous embodiments of this disclosure have been described above with a certain degree of particularity, those skilled in the art could make numerous alterations to the disclosed embodiments without departing from the spirit or scope of this disclosure.

All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the disclosed system and methods.

Additionally, joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the disclosed apparatus, system and methods as disclosed herein.

1. An object straightener device for maintaining an object in a desired position, comprising:
an object portion, said object portion comprising an object first side and an object second side, said object first side comprising an object fastener material, said object second side comprising an object adhesive material;
a wall portion, said wall portion comprising wall first side and a wall second side, said wall first side comprising a wall fastener material, said wall second side comprising a wall adhesive material;
wherein, when the object portion of the object straightener device is attached to a back and a bottom portion of the object, using the object second side containing the object adhesive material, and the wall portion of the object straightener device is attached to a wall, using the wall second side containing the wall adhesive material;
wherein, said object portion and said wall portion are not capable of holding the object on the wall and once the object is properly hung on the wall, and a desired position is attained, the object can be pressed against the wall, thereby bringing the object first side containing the object fastener material into contact with the wall first side containing the wall fastener material, and
thereby holding the object in the desired position while keeping the object portion and the wall portion hidden from sight behind the object.

2. The object straightener device for maintaining an object in a desired position in claim 1, in which the object fastener material is a hook material.

3. The object straightener device for maintaining an object in a desired position in claim 1, in which the wall fastener material is a loop material.

4. The object straightener device for maintaining an object in a desired position in claim 2, in which the hook material is made up of only a few hooks.

5. The object straightener device for maintaining an object in a desired position in claim 3, in which the loop material is made up of only a few loops.

6. The object straightener device for maintaining an object in a desired position in claim 1, in which the object portion is a square.

7. The object straightener device for maintaining an object in a desired position in claim 1, in which the object portion is a circle.

8. The object straightener device for maintaining an object in a desired position in claim 1, in which the wall portion is a triangle.

9. The object straightener device for maintaining an object in a desired position in claim 1, in which the wall portion is a square.

10. The object straightener device for maintaining an object in a desired position in claim 1, in which the wall portion is a circle.

11. The object straightener device for maintaining an object in a desired position in claim 1, wherein once the object has been pressed against the wall, bringing the object first side containing the object fastener material into contact with the wall first side containing the wall fastener material, the object can be pulled from the wall, separating the object first side containing the object fastener material from the wall first side containing the wall fastener material.

12. The object straightener device for maintaining an object in a desired position in claim 11, wherein once the object has been pulled from the wall, separating the object first side containing the object fastener material from the wall first side containing the wall fastener material, the object can be repositioned and again pressed against the wall, bringing the object first side containing the object fastener material again into contact with the wall first side containing the wall fastener material.
